(19) United States
(12) Patent Application Publication
(10) Pub. No.: US 2018/0174393 A1
(43) Pub. Date: Jun. 21, 2018

(54) FUEL DISPENSING ENVIRONMENT WITH AUTOMATED RESET OF USER INTERFACE CONTROL CIRCUITRY IN A FUEL DISPENSER

(71) Applicant: GILBARCO Inc., Greensboro, NC (US)

(72) Inventors: John Angelo Coussis, Oak Ridge, NC (US); Kenneth H. Gentry, JR., Greensboro, NC (US)

(21) Appl. No.: 15/384,796

(22) Filed: Dec. 20, 2016

(51) Int. Cl. G07F 13/02

(52) U.S. Cl. CPC G07F 13/02

(57) ABSTRACT

A fueling environment is provided including a plurality of fuel dispensers. Each of the plurality of fuel dispensers includes a user interface for receiving payment information. The fueling environment also includes a dispenser hub comprising processing circuitry. The dispenser hub processing circuitry is configured to receive status data regarding user interface control circuitry of the fuel dispenser, compare the status data to one or more predetermined conditions, and cause the user interface control circuitry to be reset in response to the status data satisfying a predetermined condition of the one or more predetermined conditions.

### FIELD OF THE INVENTION

The present invention relates generally to service stations at which fuel is dispensed. More particularly, the present invention relates to a fuel dispensing environment including automated reset of user interface control circuitry in a fuel dispenser.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. In other cases, the customer may want or need to go into the convenience store to pay for the fuel or to purchase other items.

The convenience store will generally be equipped with a point-of-sale (POS) system to handle certain functions relating to transactions that occur in the retail fueling environment. Transactions are recorded using the POS for inventory reconciliation and other recordkeeping purposes. In addition, the POS may allow the station's manager the ability to set options associated with the POS or the service station, such as the appearance of receipts issued by the station's dispensers.

### SUMMARY OF CERTAIN ASPECTS

The present invention recognizes and addresses the foregoing considerations, and others, of prior art construction and methods. In this regard, certain exemplary and non-limiting aspects of the present invention will now be described. These aspects are intended to provide some context for certain principles associated with the present invention, but are not intended to be defining of the full scope of the present invention.

A fueling environment is provided including a plurality of fuel dispensers. Each of the fuel dispensers includes user interface control circuitry operative to control components (such as a card reader) of the dispenser's user interface. The fueling environment also includes a dispenser hub comprising processing circuitry. The processing circuitry is configured to receive status data from the user interface control circuitry at predetermined points of a transaction, compare the status data to one or more predetermined conditions, and cause the user interface control circuitry to be reset in response to the status data satisfying a predetermined condition.

Additional embodiments may include apparatuses and methods similar to those described above with respect to the fuel dispensing environment. Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fueling environment incorporating certain aspects of the present invention.

FIG. 2A is a diagrammatic representation showing additional details of the enhanced dispenser hub of FIG. 1.

FIG. 2B is a diagrammatic representation showing additional details of the enhanced dispenser hub including a respective interface for each set of user interface control circuitry in the fuel dispensers.

FIG. 3 is a diagrammatic representation showing additional details of a fuel dispenser shown in FIG. 1.

FIG. 4 illustrates a block diagram of one example of a processing circuitry according to an embodiment of the present invention.

FIG. 5 illustrates a method of resetting user interface control circuitry in a fuel dispenser according to an example embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

In some instances, user interface control circuitry in a fuel dispenser, referred to herein as the CRIND (card reader in dispenser), may experience a software “hang” or “lockup” (e.g., a program or system ceases to respond to inputs, or may otherwise become unusable due to external communication issues or software bugs). Typically, a dispenser hub used to communicate between fuel dispensers including at least one CRIND and a financial institution has been restarted to restore the CRIND to operation. However, restarting the dispenser hub may prevent any fueling transactions in the entire fueling environment from taking place for five to forty-five minutes while the dispenser hub initializes. In example embodiments discussed herein, the dispenser hub may be configured to detect fault conditions associated with a CRIND and automatically trigger a reset of a single CRIND, or both CRINDs associated with a single fuel dispenser. Resetting a single CRIND avoids a full dispenser hub (or POS) restart and allows for transactions to continue at other fuel dispensers, or even the opposite side of the fuel dispenser associated with the CRIND being reset.

### Example Fueling Environment

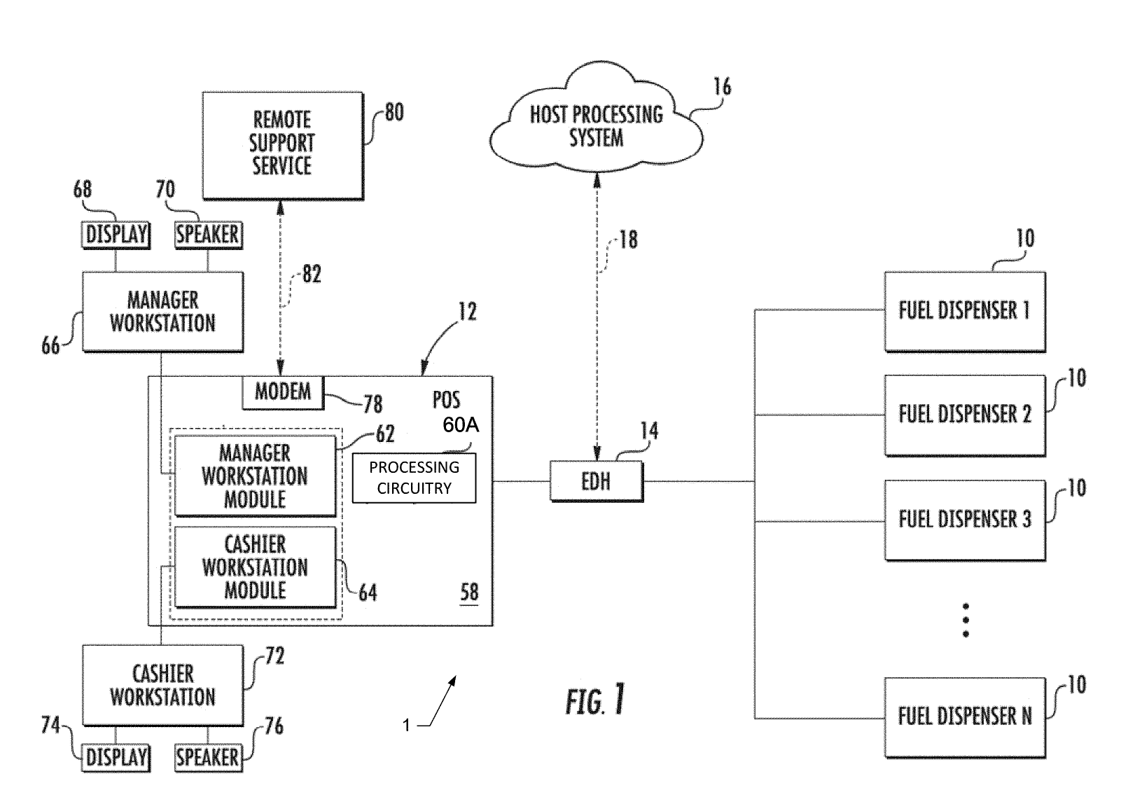

FIG. 1 illustrates an exemplary retail fueling environment 1 in accordance with an embodiment of the present invention. One or more fuel dispensers 10 are located in the forecourt region of the retail fueling environment. The fuel dispensers 10 are operative to dispense fuel supplied from one or more underground storage tanks (USTs) into a customer's vehicle. Typically, the fuel dispensers 10 will be provided with “pay-at-the-pump” capability, allowing the customer to authorize and pay for the fueling transaction at the dispenser itself. The retail fueling environment 1 also includes a point-of-sale (POS) system 12 that handles in-store sales activities, as well as various inventory and configuration functions.

Although embodiments are contemplated in which the electronic payment server is incorporated into or is in direct communication with POS 12, the illustrated embodiment utilizes an enhanced dispenser hub (EDH) 14 as shown and described in U.S. Pat. No. 8,438,064 (incorporated fully herein by reference for all purposes). EDH 14 includes an electronic payment server that allows processing of payment card information. In particular, credit (or debit) card information from the fuel dispensers 10 and any in-store card readers is fed to EDH 14, which seeks approval from a remote host processing system 16 via a suitable off-site communication link 18.

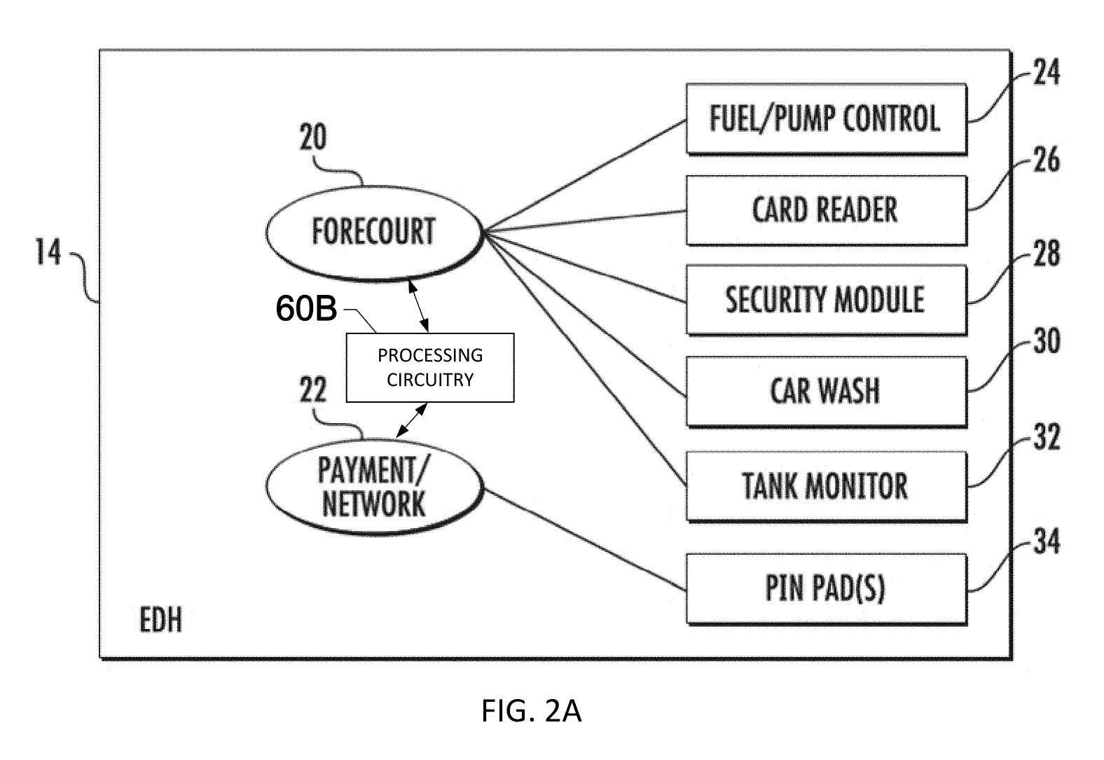

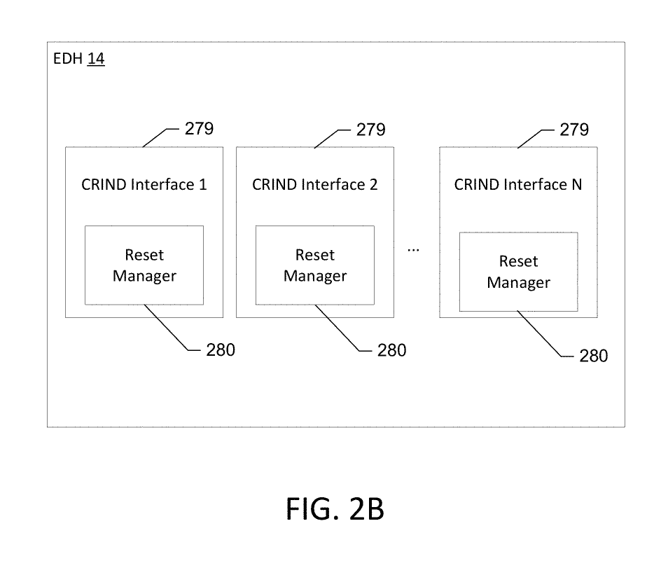

Referring now to FIG. 2A, EDH 14 includes processing circuitry 60B for running a forecourt module 20 and a payment/network module 22. Forecourt module 20 is adapted to control the operation of devices located in the retail fueling environment's forecourt. In this example, forecourt module 20 comprises several modules, including fuel/pump control module 24, card reader module 26, security module 28, car wash module 30, and tank monitor module 32. The fuel/pump control module 24 handles operation of dispensers 10, while the car wash module 30 handles operation of any on-site car washes. The tank monitor module 32 handles operation of any tank monitors connected to the underground storage tanks of the retail fueling environment. The card reader module 26 handles operation of the card readers of the retail fueling environment, such as the card readers of dispensers 10. The security module 28 handles encryption of the sensitive information transmitted by the components of the retail fueling environment. For instance, payment card data received by the various card readers in the retail fueling environment may be handled by the card reader module 26 and encrypted by the security module 28.

Payment module 22 performs validation of the payment card information received by the various card readers in the retail fueling environment. In particular, payment module 22 handles communications to and from the host processing system 16. As shown, payment module 22 communicates with a PIN pad module 34 when information from a PIN pad is necessary to process the transaction. As noted above, the dispenser hub may be a separate device as shown or may be incorporated into POS 12.

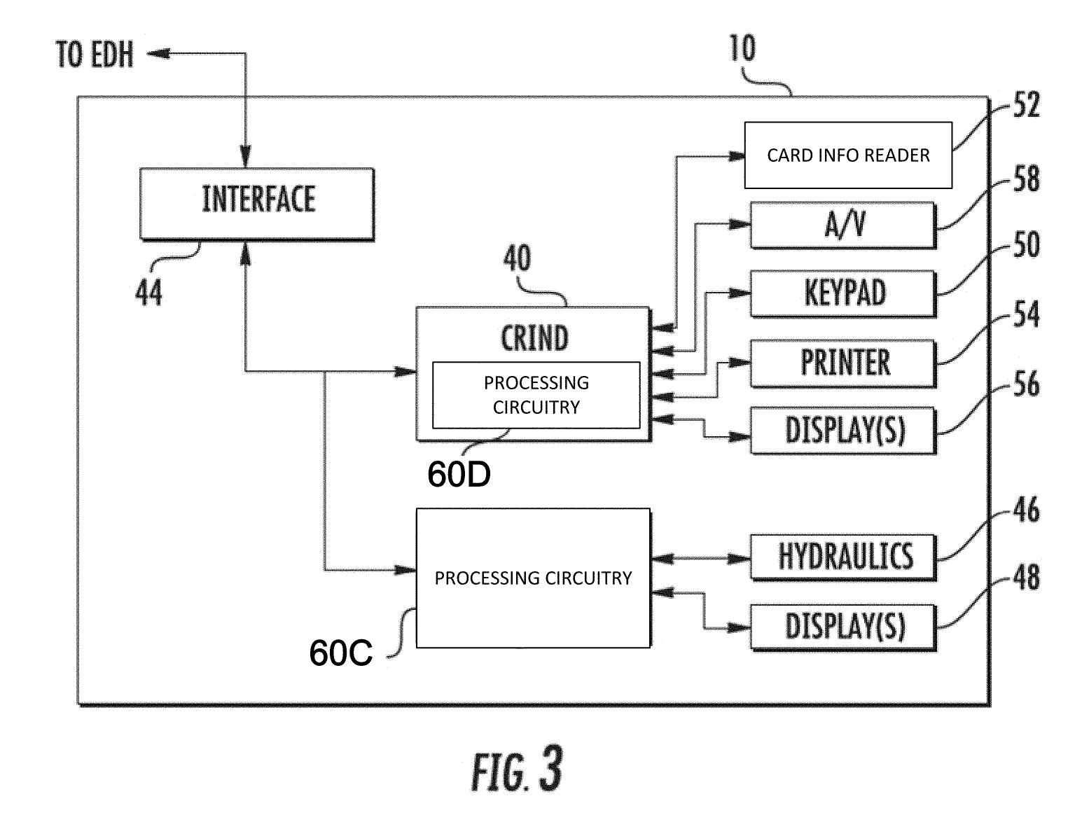

FIG. 2B illustrates an example embodiment of the EDH 14 wherein a respective CRIND interface 279 is configured to receive and send data communications between the EDH 14 and a respective CRIND module 40 (FIG. 3). Each such CRIND interface 279 may be a software-based application, a hardware communication interface, or combination thereof. Further, the CRIND interface 279 may be embodied in the processing circuitry 60B, the forecourt module 20, card reader module 26, or combination thereof. A CRIND reset manager 280 is associated with each CRIND interface 279. In particular, the CRIND reset manager 280 may be common to all of the CRIND interfaces or a separate CRIND reset manager 280 may be utilized for each CRIND interface 279. In either case, the CRIND reset manager 280 monitors communication between the CRIND module 40 and the EDH 14 via the CRIND interfaces 279. In an instance in which the CRIND reset manager 280 detects a fault condition associated with a CRIND interface 279, the CRIND reset manager 280 may automatically trigger a reset of a single CRIND, as discussed in further detail below.

Referring now to FIG. 3, additional details regarding the various components of fuel dispenser 10 can be more easily explained. As shown, fuel dispenser 10 includes processing circuitry 60C. In addition, dispenser 10 may also comprise a CRIND module 40 which may be associated with or include processing circuitry 60D. (As noted above, CRIND module 40 and its associated processing circuitry 60D may be referred to generally as user interface control circuitry.) Those of ordinary skill in the art are familiar with CRIND units used in fuel dispensers, but additional background information is provided in U.S. Pat. No. 4,967,366, the entirety of which is incorporated by reference herein for all purposes.

As shown, processing circuitry 60C and CRIND module 40 of the fuel dispenser 10, are in operative communication with EDH 14 via an interface 44. In addition, either or both of processing circuitry 60C and CRIND module 40 may be in wired or wireless communication with the internet and/or one or more cloud servers via off-site communication link 18 (FIG. 1), or another suitable communication link.

Processing circuitry 60C includes the hardware and software necessary to control the hydraulic components and functions of dispenser 10. Those of ordinary skill in the art are familiar with the operation of the hydraulics 46 of dispenser 10. In general, however, fuel from USTs is pumped through a piping network into an inlet pipe. Fuel being dispensed passes though a flow meter, which is responsive to flow rate or volume. A displacement sensor, such as a pulser, is employed to generate a signal in response to fuel flow though the meter and communicate this information to processing circuitry 60C. Processing circuitry 60C may also provide control signaling to a valve that may be opened and closed to permit or not permit dispensing of fuel.

Meter flow measurements from the displacement sensor are collected by processing circuitry 60C. Processing circuitry 60C also typically performs calculations such as cost associated with a fuel dispensing transaction. As a dispensing transaction progresses, fuel is then delivered to a hose and through a nozzle into the customer's vehicle. Dispenser 10 includes a nozzle boot, which may be used to hold and retain the nozzle when not in use. The nozzle boot may include a mechanical or electronic switch in communication with processing circuitry 60C to indicate when the nozzle has been removed for a fuel dispensing request and when the nozzle has been replaced, signifying the end of a fueling transaction. Processing circuitry 60C may thus determine whether a transaction has been initiated or completed.

Processing circuitry 60C may further be operative to control one or more displays 48. For example, a transaction price total display may present customers with the price for fuel that is dispensed. A transaction gallon total display may be used to present customers with the measurement of fuel dispensed in units of gallons (or liters). Finally, price per unit (PPU) displays may be provided to show the price per unit of fuel dispensed in either gallons or liters, depending on the programming of dispenser 10.

CRIND module 40 includes processing circuitry 60D configured to support payment processing and peripheral interfaces at dispenser 10. In this regard, CRIND module 40 may be in operative communication with several input devices. For example, a PIN pad 50 is typically used for entry of a PIN if the customer is using a debit card for payment of fuel or other goods or services, and may be used for entry of the customer's postal code (e.g., zip code) corresponding to the billing address for a credit transaction. CRIND module 40 may also be in operative communication with a card information reader 52 for accepting credit, debit, or other cards for payment (which may be, for example, magnetic stripe or chip cards). Additionally, card information reader 52 may accept loyalty or program-specific cards as is well known. Moreover, card information reader 52 may receive payment information via wireless near-field communication (NFC) link or the like. Further, CRIND module 40 may be in operative communication with other payment or transactional devices such as a receipt printer 54.

One or more display(s) 56 may be used to display information, such as transaction-related prompts and advertising, to the customer. The customer may use soft keys to respond to information requests presented to the user via a display 56. In some embodiments, however, a touch screen may be used for display 56. In this case, display 56 may be configured to display a virtual keypad for receiving payment data such as a PIN of a debit card or the billing postal (zip) code of a credit card, for instance. Display 56 may also be used in this case to receive a selection from the customer regarding the displayed information.

Audio/video electronics 58 are adapted to interface with the CRIND module 40 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Referring again to FIG. 1, POS 12 includes a server 58 having processing circuitry 60A. In the present example, processing circuitry 60A executes several software modules including manager workstation module 62 and cashier workstation module 64. When executed, manager workstation module 62 displays a graphical user interface (GUI) on manager workstation 66 that allows the owner, operator, or manager of the fueling station to set options for the fueling environment. Manager workstation module 66 is also adapted to provide various point-of-sale (POS) capabilities, including the ability to conduct transactions for items offered for sale by the fueling station. Toward this end, manager workstation 66 includes a suitable display 68, such as a touchscreen display, and may further include one or more speakers 70. As one skilled in art will appreciate, server 58 and manager workstation 66 may be incorporated into the same hardware.

Similarly, cashier workstation module 64 provides the station's cashier, clerk, or employee the means necessary to effect a transaction for one or more items or services offered by the fueling station. Cashier workstation module 64 communicates with the hardware of cashier workstation 72, which includes its own display 74 and optional speaker(s) 76.

In operation, a user positions a vehicle adjacent to one of dispensers 10 and uses the dispenser to refuel the vehicle. For payment, the user typically inserts and removes a payment card from card information reader 52. Card information reader 52 reads the information on the payment card and transmits the information to forecourt module 20 via the CRIND module 40 and card reader module 26. The forecourt module 20 provides the payment information to network payment module 22, which contacts the appropriate host processing system 16 operated by the financial institution associated with the user's payment card. The financial institution either validates or denies the transaction and transmits such a response to network payment module 22. The information received from the financial institution's host computer system is transmitted from network payment module 22 back to forecourt module 20 to handle appropriately. This may include transmitting to dispenser 10 a request that the user provide another payment card if the transaction is denied, or printing a receipt if authorized.

For additional information regarding retail fueling environments, reference is made to U.S. Pat. No. 6,435,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), and U.S. Pat. No. 6,935,191 (“entitled “Fuel Dispenser Fuel Flow Meter Device, System and Method”), all of which are hereby incorporated by reference for all purposes as if set forth verbatim herein.

Generally, it is necessary or desirable to provide remote support capability for POS 12. In this regard, POS 12 includes a modem 78 (or other suitable communication portal) that allows communication with a remote support service 80 via a suitable communication link 82. When remote access is desired, store personnel utilizing POS 12 (e.g., using manager workstation 66) will enable modem 78 so that the modem 78 will “answer the phone.” If the remote support service provides the correct password as supplied to the remote service agent by the store personnel, remote access will be permitted.

### Example CRIND Reset Process

The process for completing a transaction at an unattended fuel dispenser 10 is a multi-step process that utilizes both internal hardware components, e.g. card information reader, 52, keypad 50, printer, 54, displays 56, CRIND module 40, and the like, and interfaces to external systems, e.g. the EDH 14, host processing system 16, or the like. One or more portions of the transaction process may be serially driven, i.e., a first step must be completed prior to moving to a second step. In an instance in which an error occurs or a step cannot be completed, the serially driven process or sequence may prevent the CRIND module 40 from performing subsequent steps, e.g. the CRIND module 40 may “hang” or “lockup.”

In one example, hardware components within the fuel dispenser 10, such as the card information reader 52, keypad 50, or the like, may respond to the CRIND module 40 with unexpected or invalid data. The unexpected or invalid data may prevent the CRIND module 40 from proceeding to the next subsequent step, which may in turn prevent the transaction process from completing its sequence. Additionally or alternatively, one or more of the hardware components may respond outside of a predetermined communication period, e.g. an expected period in which the processing circuitry 60D is configured to receive valid data, such as a time out period. In an instance in which a response is received from one or more of the hardware components outside of the predetermined communication period, an exception condition may be generated. The CRIND module 40 may, in some instances accept the response from the one or more hardware components outside of the predetermined communication period with an exception condition or the response may cause a “hang” or “lockup.”

The transaction process may include interaction with external systems including the host processing system 16, e.g. financial institutions or reward or loyalty program servers. Interactions with the external systems may also lead to a “hang” or “lockup” of the CRIND module 40, due to unexpected or incorrect responses. For example, the transaction may enter an invalid or unrecoverable state due to a failed credit card “pre-authorization” prior to the fueling operation or a failed transaction completion at the end of the fueling operation. The invalid or unrecoverable state may be caused by one or more responses from the host processing system 14 delivered out of sequence, or incorrectly formed response messages.

The CRIND module 40 may enter an unrecoverable state due to fueling environment 1 internal errors, such as hardware malfunction, database failure, or the like within the POS 12, the EDH 14, the CRIND module 40, or the like. In an example embodiment, the CRIND module 40 may also enter an unrecoverable state due to an error in transaction logic associated with the CRIND module 40.

Embodiments of the present invention are configured to address such “hang” and lockup” scenarios. As shown in FIG. 2B, the EDH 14 preferably maintains a plurality of CRIND interfaces 279 respectively corresponding to each fuel dispenser 10 in the forecourt or for each door, or fueling side, of the respective fuel dispensers 10. The CRIND reset manager(s) 280 may include state and transaction information representing a specific CRIND module 40. At one or more predetermined points of a card transaction, the processing circuitry 60B may receive CRIND status data. The processing circuitry 60B may compare the status data to one or more predetermined conditions. The predetermined conditions may include normal operational conditions, transaction data, and/or error conditions, which may be indicative of a “hang” or “lockup.” For example, normal condition status data may include a transaction step indicator and/or a completion status. Error conditions may be indicative of a communication or software defect or error. The error conditions may include a transaction step and a time out indicator, e.g. an indication that no response was received within a predetermined communication time, an invalid communication indicator, an unexpected communication error, or the like. The predetermined error conditions may be further indicative of a condition in which the CRIND module 40 has entered, or is likely to enter, an unrecoverable state.

In response to the status data satisfying a predetermined error condition, the processing circuitry 60B may cause the CRIND module 40 to reset to clear the error. Resetting of the CRIND module 40 preferably includes only the specific CRIND module 40 indicating an error condition. As a result, there may be no need to restart the EDH 14 or reset unaffected CRIND modules 40 in the overall fueling environment. Resetting the CRIND module 40 may include a “soft reset,” e.g. a software reset of the CRIND module 40. A soft reset may include one or more of terminating input/output functions of the CRIND module 40, terminating the “hung” software function, initializing a transaction process for the CRIND 40, or the like, without interruption of power to the CRIND. Additionally or alternatively, resetting the CRIND module 40 may include a “hard reset,” e.g., temporary interruption of power to the CRIND module 40, such as 1 second or 10 seconds interruption. The interruption of power to the CRIND module 40 may cause the CRIND module 40 to reinitialize all programs including the transaction process.

In some example embodiments, the processing circuitry 60B may be configured to cause a soft reset in the first instance of an error condition. The processing circuitry 60B may be configured to cause a hard reset in response to a subsequent error condition. In some instances, the processing circuitry 60B may consider a further error condition a subsequent error condition, in an instance in which the error condition is satisfied within a predetermined period of time from the first error condition, such as 1 minute, 3 minutes, 5 minutes, or the like. In an instance in which a further error condition occurs beyond the predetermined time period the processing circuitry 60B may consider the error condition a first instance error condition. In some example embodiments, the processing circuitry 60B may be configured to attempt two or more soft resets before causing a hard reset.

In an example embodiment, the processing circuitry 60B may cause an alert indicating that reset of the CRIND module 40 has occurred. The alert may comprise an audio and/or visual indication, such as a ding, beep and/or a dialog box on the display 74 of the casher station 72, the display 68 of the manager workstation 66, or other user interface associated with the POS 12. Additionally or alternatively, the alert may include textual information transmitted to the remote support service 80, such as via modem 78. The textual information may include one or more of the error condition, transaction step, invalid or unexpected response data, time of occurrence, a fuel dispenser identifier or CRIND identifier, reset type, e.g. soft or hard, or the like.

In some instances, the processing circuitry 60B may determine if the reset was successful, such as by receiving status data from the CRIND module 40 which are indicative of normal operation. In response, the alert (or a further alert) may indicate that the reset of the CRIND module 40 was successful and/or no further action is necessary. In response to determining the reset was unsuccessful, such as a failure to receive status data indicative of normal operation, the alert may indicate that the reset of the CRIND module 40 was unsuccessful and/or that further action is necessary to return the CRIND module 40 to operation. Such further action may include contacting a technical support help desk or establish communications with the remote support service 80.

In some example embodiments, the processing circuitry 60B may be configured to automatically cause the alert to be sent to the remote support service 80 in response to a subsequent error condition. Additionally or alternatively, the processing circuitry 60B may establish communication with the remote support service 80. In response, the remote support service 80 may read diagnostic information from the POS 12, the EDH 14, the CRIND module 40, the fuel dispenser 10, or the like. In some instances, the remote support service 80 may establish remote control of at least a portion of the fueling environment 1, such as the POS 12, the EDH 14, the CRIND module 40, the fuel dispenser 10, or the like, as necessary or desired. The remote support service 80 may cause the processing circuitry 60B to run one or more diagnostic tests to identify software and/or hardware faults in the fueling environment and in some instances correct faults, such as by reconfiguring the processing circuitry 60B.

### Example Processing Circuitry

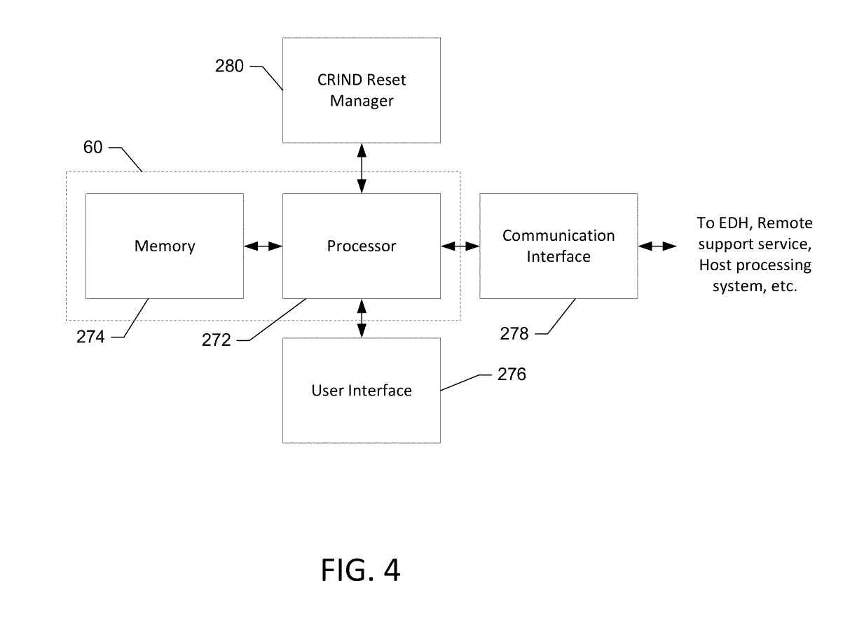

FIG. 4 shows certain elements of processing circuitry 60 for a POS 12, EDH 14, fuel dispenser 10, and/or CRIND module 40. The processing circuitry 60 of FIG. 4 may be employed, for example, on onboard circuitry within the POS 12, EDH 14, fuel dispenser 10, and/or CRIND module 40 in circuitry associated with a convenience store, a network device, server, proxy, or the like, as discussed above in reference to processing circuitry 60A, 60B, 60C, and 60D of FIGS. 1, 2A, and 3, respectively. Alternatively, embodiments may be employed on a combination of devices. Furthermore, it should be noted that the devices or elements described below may not be mandatory and thus some may be omitted in certain embodiments.

In an example embodiment, the processing circuitry 60 is configured to perform data processing, application execution and other processing and management services according to an example embodiment of the present invention. The processing circuitry 60 may include a processor 272 and a memory 274. As shown, processor 272 may be in communication with or otherwise control a user interface 276 and a communication interface 278.

The processing circuitry 60 may be embodied as a circuit chip (e.g. an integrated circuit chip) configured (e.g. with hardware, software or a combination of hardware and software) to perform operations described herein. However, in some embodiments, processing circuitry 60 may be embodied as a portion of a server, computer, or workstation. In situations where the processing circuitry 60 is embodied as a server or at a remotely located computing device, the user interface 276 may be disposed at another device (e.g., at a computer terminal or client device such as the fuel dispenser 10) that may be in communication with the processing circuitry 60 via the communication interface 278 and/or a network.

The network may be a data network, such as a local area network (LAN), a metropolitan area network (MAN), a wide area network (WAN) (e.g., the Internet), and/or the like, which may couple the fuel dispenser 10 to devices such as processing elements (e.g., computer terminals, server computers or the like) and/or databases. Communication may be accomplished by either wireline or wireless communication mechanisms and corresponding communication protocols.

The user interface 276 may be an input/output device for receiving instructions directly from a user. The user interface 276 may be in communication with the processing circuitry 60 to receive user input via the user interface 276 and/or to present output to a user as, for example, audible, visual, mechanical or other output indications. The user interface 276 may include, for example, a keyboard, a mouse, a joystick, a display (e.g., a touch screen display), a microphone, a speaker, or other input/output mechanisms. Further, the processing circuitry 60 may comprise, or be in communication with, user interface circuitry configured to control at least some functions of one or more elements of the user interface 276. The processing circuitry 60 and/or user interface circuitry may be configured to control one or more functions of one or more elements of the user interface 276 through computer program instructions (e.g., software and/or firmware) stored on a memory device accessible to the processing circuitry 60 (e.g., volatile memory, non-volatile memory, and/or the like). In some example embodiments, the user interface circuitry is configured to facilitate user control of at least some functions of the apparatus through the use of a display configured to respond to user inputs. The processing circuitry 60 may also comprise, or be in communication with, display circuitry configured to display at least a portion of a user interface 276, the display and the display circuitry configured to facilitate user control of at least some functions of the apparatus.

The communication interface 278 may be any means such as a device or circuitry embodied in either hardware, software, or a combination of hardware and software that is configured to receive and/or transmit data from/to a network and/or any other device or module in communication with the processing circuitry 60, the POS 12, and/or EDH 14 of the fueling environment (and/or a remote cloud server, either directly or via a router located in the convenience store). In some instances the communications interface 278 may be referred to as a cloud connection processor (CCP) and may provide secured, e.g. encrypted, communication between the processing circuitry, the network, and/or remote servers. The communication interface 278 may also include, for example, an antenna (or multiple antennas) and supporting hardware and/or software for enabling communications with the network or other devices (e.g., a user device). In some environments, the communication interface 278 may alternatively or additionally support wired communication. As such, for example, the communication interface 278 may include a communication modem and/or other hardware/software for supporting communication via cable, digital subscriber line (DSL), universal serial bus (USB) or other mechanisms. In an exemplary embodiment, the communication interface 278 may support communication via one or more different communication protocols or methods. In some cases, IEEE 802.15.4 based communication techniques such as ZigBee or other low power, short range communication protocols, such as a proprietary technique based on IEEE 802.15.4 may be employed along with radio frequency identification (RFID) or other short range communication techniques.

In some example embodiments, the processing circuitry may include or be in communication with a CRIND reset manager 280. The CRIND reset manager 280 may be configured to monitor the CRIND module 40 as described above and cause the CRIND module 40 to reset in response to determining that status data regarding the CRIND module or host network communications satisfies one or more predetermined conditions indicative of an error.

### Example Flowchart(s) and Operations

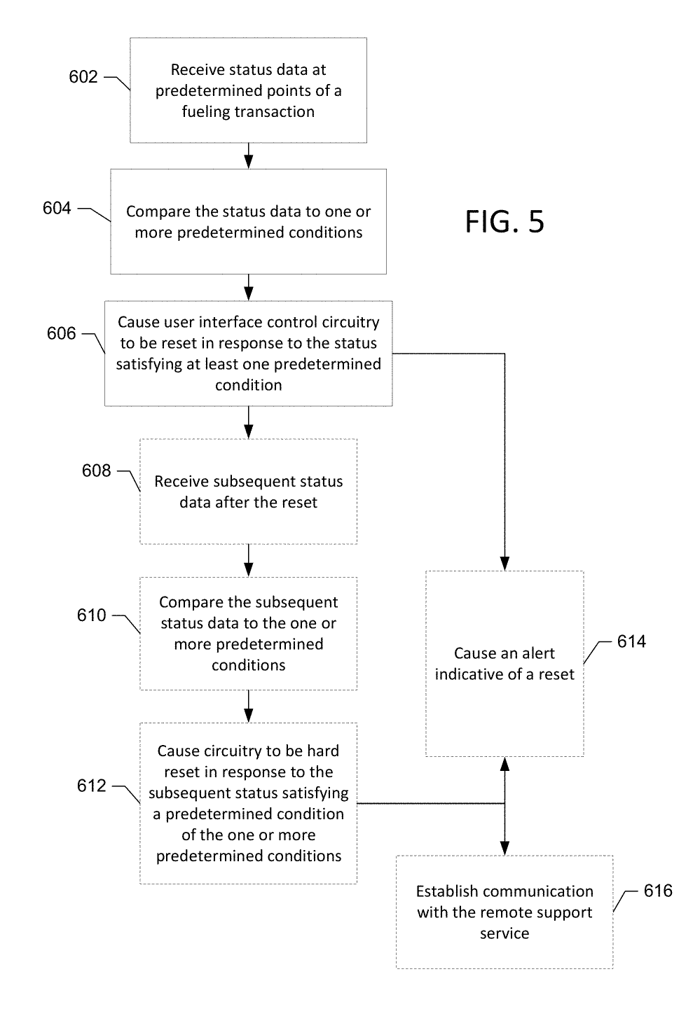

Embodiments of the present invention provide methods, apparatus and computer program products for resetting user interface control circuitry in a fuel dispenser. Various examples of the operations performed in accordance with embodiments of the present invention will now be provided with reference to FIG. 5.

FIG. 5 illustrates a flowchart according to example methodology of the present invention. The operations illustrated in and described with respect to FIG. 5 may, for example, be performed by, with the assistance of, and/or under the control of one or more of the processor 272, memory 274, user interface 276, and/or communication interface 278. The method may include receiving status data at predetermined points of a payment transaction at operation 602, comparing the status data to one or more predetermined conditions at operation 604, and causing user interface control circuitry (e.g., CRIND module 40) to be reset in response to the status data from the card reader satisfying at least one predetermined condition.

In some embodiments, the method may include additional, optional operations, and/or the operations described above may be modified or augmented. Some examples of modifications, optional operations, and augmentations are described below, as indicated by dashed lines, such as, receiving subsequent status data after the reset at operation 608, comparing the subsequent status data to the one or more predetermined conditions at operation 610, and causing the user interface control circuitry to be hard reset in response to the subsequent status data satisfying a predetermined condition of the one or more predetermined conditions at operation 612. The method may further include causing an alert indicative of a reset at operation 614 and/or establishing communication with the remote support service at operation 616.

FIG. 5 illustrates a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 274 and executed by, for example, the processor 272. As will be appreciated, any such computer program product may be loaded onto suitable hardware (e.g., a computer or other programmable apparatus) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable mediums can direct a computer or other programmable device (for example, control system 40 of the fuel dispenser 10) to cause a series of operations to be performed on the computer or other programmable apparatus to produce a computer-implemented process such that the instructions which execute on the computer or other programmable apparatus implement the functions specified in the flowchart block(s).

Many modifications and other embodiments of the invention set forth herein will come to mind to one skilled in the art to which this invention pertains having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A fueling environment comprising:
a plurality of fuel dispensers, wherein each of the plurality of fuel dispensers has user interface control circuitry to receive payment information;
a dispenser hub comprising processing circuitry configured to:
receive status data during a payment transaction;
compare the status data to one or more predetermined conditions; and
cause the user interface control circuitry to be reset in response to the status data satisfying a predetermined condition of the one or more predetermined conditions.

2. The fueling environment of claim 1, wherein satisfying the one or more predetermined conditions is indicative of a communication or software defect.

3. The fueling environment of claim 1, wherein the reset comprises causing the fuel dispenser to cycle power to the user interface control circuitry.

4. The fueling environment of claim 1, wherein the reset comprises a software reset of the user interface control circuitry.

5. The fueling environment of claim 1, wherein the dispenser hub processing circuitry is further configured to:
receive subsequent status data after the reset;
compare the subsequent status data to the one or more predetermined conditions; and
cause the user interface control circuitry to be hard reset in response to the subsequent status satisfying a predetermined condition of the one or more predetermined conditions, wherein a hard reset comprises causing the fuel dispenser to cycle power to the user interface control circuitry.

6. The fueling environment of claim 1, wherein the dispenser hub processing circuitry is further configured to:
cause an alert indicative of the reset.

7. The fueling environment of claim 6, wherein the alert indicates that the reset has been completed and no further action is necessary.

8. The fueling environment of claim 6, wherein the alert indicates that the reset has been completed and further action is necessary.

9. The fueling environment of claim 6, wherein the alert is transmitted to a remote support service.

10. The fueling environment of claim 6, wherein the dispenser hub processing circuitry is further configured to:
receive subsequent status data after the reset;
compare the subsequent status data to the one or more predetermined conditions; and
in response to the subsequent status data satisfying a predetermined condition of the one or more predetermined conditions,
cause the alert to be transmitted to a remote support service, and
establish communication with the remote support service, wherein the communication comprises remote control of at least a portion of the dispenser hub processing circuitry.

11. A fuel dispenser hub comprising:
processing circuitry configured to:
receive status data during a payment transaction from one of a plurality of fuel dispensers, wherein each of the plurality of fuel dispensers comprises at least one user interface that receives payment information;
compare the status data to one or more predetermined conditions; and
cause user interface control circuitry of a fuel dispenser to be reset in response to the status data satisfying a predetermined condition of the one or more predetermined conditions.

12. The fuel dispenser hub of claim 11, wherein satisfying the one or more predetermined conditions is indicative of a communication or software defect.

13. The fuel dispenser hub of claim 11, wherein the reset comprises causing the fuel dispenser to cycle power to the user interface control circuitry.

14. The fuel dispenser hub of claim 11, wherein the reset comprises a software reset of the user interface control circuitry.

15. The fuel dispenser hub of claim 11, wherein the processing circuitry is further configured to:
receive subsequent status data after the reset;
compare the subsequent status data to the one or more predetermined conditions; and
cause the user interface control circuitry to be hard reset in response to the subsequent status data satisfying a predetermined condition of the one or more predetermined conditions, wherein a hard reset comprises causing the fuel dispenser to cycle power to the user interface control circuitry.

16. The fuel dispenser hub of claim 11, wherein the processing circuitry is further configured to:
cause an alert indicative of the reset.

17. The fuel dispenser hub of claim 16, wherein the alert indicates that the reset has been completed and no further action is necessary.

18. The fuel dispenser hub of claim 16, wherein the alert indicates that the reset has been completed and further action is necessary.

19. The fuel dispenser hub of claim 16, wherein the alert is transmitted to a remote support service.

20. The fuel dispenser hub of claim 16, wherein the processing circuitry is further configured to:
receive subsequent status data after the reset;
compare the subsequent status data to the one or more predetermined conditions; and
in response to the subsequent status data satisfying a predetermined condition of the one or more predetermined conditions,
cause the alert to be transmitted to a remote support service, and
establish communication with the remote support service, wherein the communication comprises remote control of at least a portion of the processing circuitry.

21. The fuel dispenser hub of claim 16, wherein said fuel dispenser hub is incorporated into a POS system.
